(19) United States
(12) Patent Application Publication
(10) Pub. No.: US 2002/0005824 A1
(43) Pub. Date: Jan. 17, 2002

(54) Display apparatus

(76) Inventors: Hiroshi Oshitani, Amagasaki-Shi (JP); Kiyofumi Hashimoto, Suita-Shi (JP); Masakazu Okada, Kyoto-Shi (JP); Katsuhiko Asai, Takatsuki-Shi (JP)

Correspondence Address: SIDLEY AUSTIN BROWN & WOOD, 717 NORTH HARWOOD, SUITE 3400, DALLAS, TX, 75201, US

(21) Appl. No.: 09/887,796

(22) Filed: Jun. 22, 2001

(30) Foreign Application Priority Data
Jun. 23, 2000 (JP) 2000-189283
Jun. 29, 2000 (JP) 2000/196496

(51) Int. Cl. G09G 3/30

(52) U.S. Cl. 345/76

(57) ABSTRACT

A display apparatus of the present invention has a display element which emits no light therefrom, and an electroluminescent element provided on a viewer side of the display element for a direct illumination of the display element.

The invention is based on Patent Application Nos. 2000-189283 and 2000-196496, filed in Japan, the contents of which are hereby incorporated by reference.

### FIELD OF THE INVENTION

The present invention relates to a display apparatus and its manufacturing method.

### BACKGROUND OF THE INVENTION

A liquid crystal element has been used so widely in a variety of devices for the purpose of displaying images, letters, and symbols. One typical example of the devices is a portable information device or computer such as personal digital assistant (PDA). Generally, the liquid crystal element used in such device is required to be compact, lightweight, and easy to be designed into various configurations.

In the meantime, a technique has been proposed in which an organic electroluminescent element is used for a light source. For example, the Japanese Patent Publication 11-307241 (A) discloses a lightening device in which the organic electroluminescent component is used for the light source. Specifically, FIG. 8 illustrates a schematic cross-sectional view of the lightening device disclosed in the publication. The lightening device 61 has an organic electroluminescent component 62, an auxiliary reflector 63, and a lens-like light transmitter 64. With this arrangement, light emitted from the organic electroluminescent component 62 is collected by the lens-like light transmitter 64 into a light conducting and diffusing plate 65. Within the plate 65, light is diffused in all directions due to a light diffusing feature of the plate 65 to be used as a back light for a liquid crystal display device 105.

On the other hand, a reflection type liquid crystal element is equipped with a front light rather than the back light. The front light illuminates the display element from its front, which results in an improvement of a viewing ability of the liquid crystal element in the dark place. Specifically, the reflection type liquid crystal display element using a selective reflection feature of a cholesteric phase for display utilizes only a part of light, typically less than 50% thereof Then, it is required to guide light into the display element as much as possible and also not to arrange an optical element on a viewer side of the display element which can causes a diffusion of light to decrease a contrast of the resultant image.

In addition, the portable computer, as its name means, should be shaped and dimensioned so that it can be carried without any difficulty. This in turn provides some design restrictions on the size and dimension of data input and output portions of the portable computer.

FIG. 18 shows a schematic appearance of the conventional portable information device 200. Typically, considering the portability of the device 200, it is designed to have a box-like configuration with a size of 115 mm×80 mm×12 mm. As shown, a display 201 is provided in the largest, front portion of device. Generally, the display 201 is covered with an input touch panel so that it functions not only as a data output means but also a data input means. For example, a picture drawn on the display panel 201 with a dedicated input pen or by finger can be stored into the device 200 as an image data.

On the other hand, in order to save the energy consumption, another display element such as reflection type liquid crystal display element is becoming to be used, in which images are displayed by the reflection of light. This type of display element requires that a transparent member provided on its viewer side has a high transmittance and is unlikely to cause a diffusion of light in order to introduce light and then reflect light from the display element as much as possible. Notwithstanding this requirement, the transmittance of the transparent member has not been improved to a large extent due to an economical reason.

In any event, in order to ensure a sufficient brightness and contrast of the image, it is preferable not to arrange any members on the viewer side of the display element.

### SUMMARY OF THE INVENTION

Accordingly, a display apparatus of the present invention comprises a display element which emits no light therefrom, and an electroluminescent element provided on a viewer side of the display element for a direct illumination of the display element.

Also, a method for manufacturing a display device of the present invention comprises the steps of providing a display element, using an electroluminescent member or assembling two or more electroluminescent members to form a light source, and positioning the light source on a viewer side of the display element.

Further, another display apparatus of the present invention comprises a display element having a display region, and a transparent element positioned on a viewer side of the display element so that the transparent element covers only a part of the display region of the display element.

### BRIEF DESCRIPTION OF THE DRAWINGS

FIG. 1A is a schematic plan view of a display device according to the first embodiment of the present invention;

FIG. 1B is a partial cross sectional view of the display device in FIG. 1A;

FIG. 1C is an enlarged partial cross sectional view of the display device in FIG. 1A;

FIG. 2A is an enlarged partial cross sectional view of an organic electroluminescent light source and a protection cover;

FIG. 2B is also an enlarged partial cross sectional view of an organic electroluminescent light source and a protection cover in another embodiment;

FIG. 3A is a schematic plan view of a display device according to the second embodiment of the present invention;

FIG. 3B is a partial cross sectional view of the display device in FIG. 3A;

FIG. 4A is a schematic plan view of a display device according to the third embodiment of the present invention;

FIG. 4B is a partial cross sectional view of the display device in FIG. 4A;

FIG. 5A is a schematic plan view of a display device according to the fourth embodiment of the present invention;

FIG. 5B is a partial cross sectional view of the display device in FIG. 5A;

FIGS. 6A to 6D are partial cross sectional views of the end portion of the protection layer;

FIG. 7A is a schematic plan view of a substrate from which a plurality of L-shaped pieces of light source are cut out;

FIG. 7B is a schematic plan view in which two pieces are assembled into the light source;

FIG. 8 is a schematic partial cross sectional view of a conventional display device;

FIG. 9A is a schematic perspective view of the display device according to the sixth embodiment of the present invention;

FIG. 9B is a schematic cross sectional view of the display device shown in FIG. 9A;

FIG. 10A is schematic perspective view of the display device according to the seventh embodiment of the present invention;

FIG. 10B is a schematic cross sectional view of the display device shown in FIG. 10A;

FIG. 11A is schematic perspective view of the display device according to the eighth embodiment of the present invention;

FIG. 11B is a schematic cross sectional view of the display device shown in FIG. 11A;

FIG. 12 is an enlarged partial cross sectional view of the display device;

FIG. 13A is a front view of the display device, showing an arrangement of the light sources;

FIG. 13B is a front view of the display device, showing another arrangement of the light sources;

FIG. 14 is an enlarged partial cross sectional view of a touch panel provided on the display panel;

FIG. 15A is schematic perspective view of the display device according to the ninth embodiment of the present invention;

FIG. 15B is a schematic cross sectional view of the display device shown in FIG. 15A;

FIG. 16A is schematic perspective view of the display device according to the tenth embodiment of the present invention;

FIG. 16B is a schematic cross sectional view of the display device shown in FIG. 16A;

FIG. 17A is schematic perspective view of the display device according to the eleventh embodiment of the present invention;

FIG. 17B is a schematic cross sectional view of the display device shown in FIG. 17A;

FIG. 17C is a schematic side elevational view of the display device shown in FIG. 17A; and

FIG. 18 is a schematic perspective view of another conventional display device.

### DETAILED DESCRIPTION OF THE PREFERRED EMBODIMENTS

With reference to the drawings, preferred embodiments of the present invention will be described hereinafter.

First Embodiment

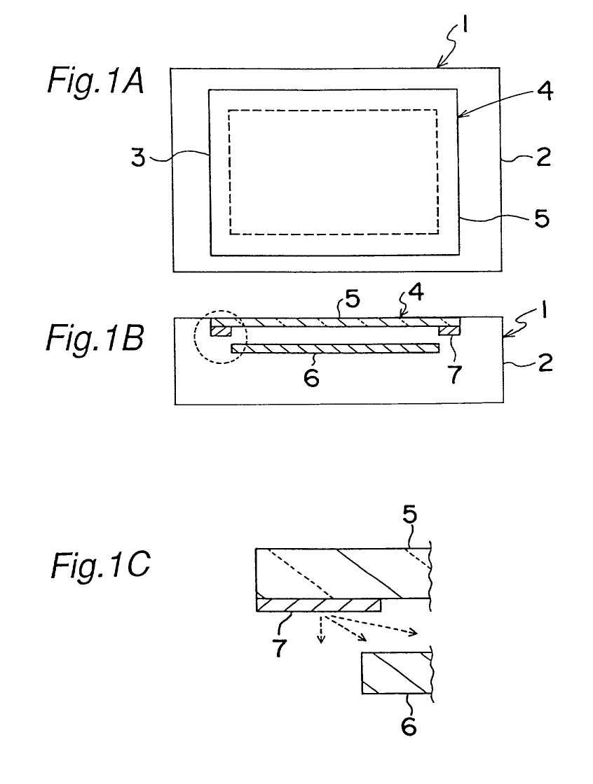

Referring to FIGS. 1A, 1B, and 1C, there is shown a portable machine or computer such as PDA generally indicated by reference numeral 1. The portable machine 1 has a housing 2 having an opening 3 defined therein, in which a display device generally indicated by reference numeral 4 of the present invention is secured.

The display device 4 has a protection cover 5 positioned in the opening 3 and a display element or panel 6 positioned behind the protection cover 5. The protection cover 5 supports a strip-like light source 7 on a periphery of its rear surface opposing the display panel 6. As can be seen from the drawings, the display panel 6 is sized so that the light source 7 surrounds the display panel 6. Preferably, the light source 7 is made of an organic electroluminescent member.

Although not shown, the portable machine 1 includes a controller (not shown) within the housing 2. The controller is electrically connected with the display panel 6 so that it controls the display panel 6 to display letters and images. The display panel 6 may be made from any one of various non-light-emitting elements. Among other things, a reflection type liquid crystal element, for example, is preferably used for the display element. The protection cover 5, which is made of transparent material such as glass and acrylic resin, for example, is fixed to the portable machine so that it covers the viewer side surface of the display panel 6.

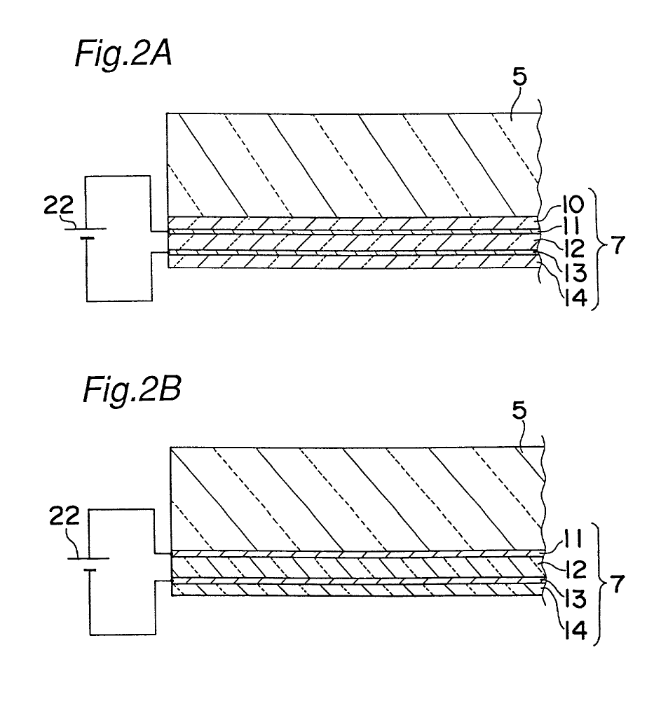

FIG. 2A illustrates an enlarged cross-sectional view of the organic electroluminescent light source 7. As shown in the drawing, the light source 7 has a plurality of layers; substrate 10, first electrode layer 11, organic light emitting layer 12, second electrode layer 13, and protection layer 14 made of transparent material. The substrate 10 may be made from a hard plate of glass or from a flexible plate of polycarbonate, polyethersulfone (PES), or polyethyleneterephthalate (PET). The electrode layers 11 and 13 and the organic emitting layer 12 may be any well-known, suitable material. In order to project light emitted at the light emitting layer 12 out of the light source 7, at least the electrode layer 13 should be made of transparent material. Also, the electrode layer 11 and 13 are preferably connected with negative and positive polarities, respectively. An electric charge injection layer and/or electric charge transport layer may be provided between the organic light emitting layer 12 and the electrodes 11 and 13, as necessary.

The substrate and layers are layered by a well-known suitable technique in which first electrode layer 11, organic light emitting layer 12, second electrode layer 13, and protection layer 14 are superimposed in this order on the substrate 10 to result in an organic light emitting sheet.

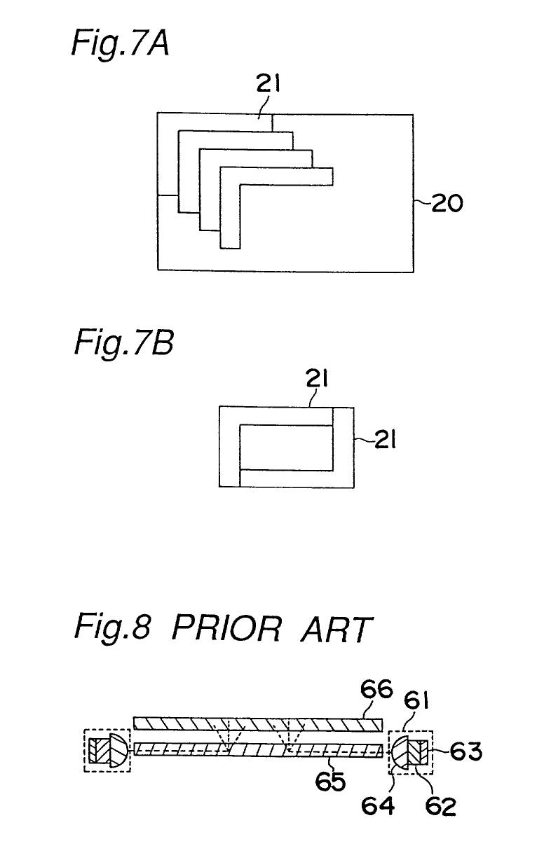

An example of the organic light emitting sheet is illustrated in FIG. 7A and indicated therein at reference numeral 20. As shown in the drawing, the organic light emitting sheet 20, which is in the form of rectangular sheet in this embodiment, is cut out into L-shaped pieces 21. Then, as shown in FIG. 7B, two L-shaped pieces 21 are assembled to form a frame-like light source, which is bonded and fixed at the periphery of the protection cover 5.

Referring back to FIG. 2A, the electrode layers 11 and 13 are connected to an external power source 22 for applying a voltage between the electrode layers 11 and 13. This allows that the organic light emitting layer 12 emits light when the voltage is applied between the electrodes 11 and 13.

As shown in FIG. 2B, the organic electroluminescent light source 7 may be formed by forming electrode layer 11, organic light emitting layer 12, electrode layer 13, and protection layer 14 on the protection cover 5. Preferably, the layers are made by the use of a well-known vapor deposition technique. However, they may be formed by another application techniques.

Referring back to FIG. 1C, when the organic light emitting layer is energized, the organic electroluminescent light source 7 emits light. The light is then projected onto the display panel 6, in particular one surface opposing to the protection layer 5, from its outside. This allows the viewer to observe the illuminated display panel 6 through the transparent protection layer 5.

As can be seen above, since the display panel 6 is illuminated by the organic electroluminescent light source 4 directly, no additional structure or function is required for the protection cover 5, for example, in order to guide light from the organic electroluminescent light source 4 toward the display panel 6. This allows the protection layer 5 to be made by a material with an elevated transmittance, which results in a highly bright image to the viewer.

Second Embodiment

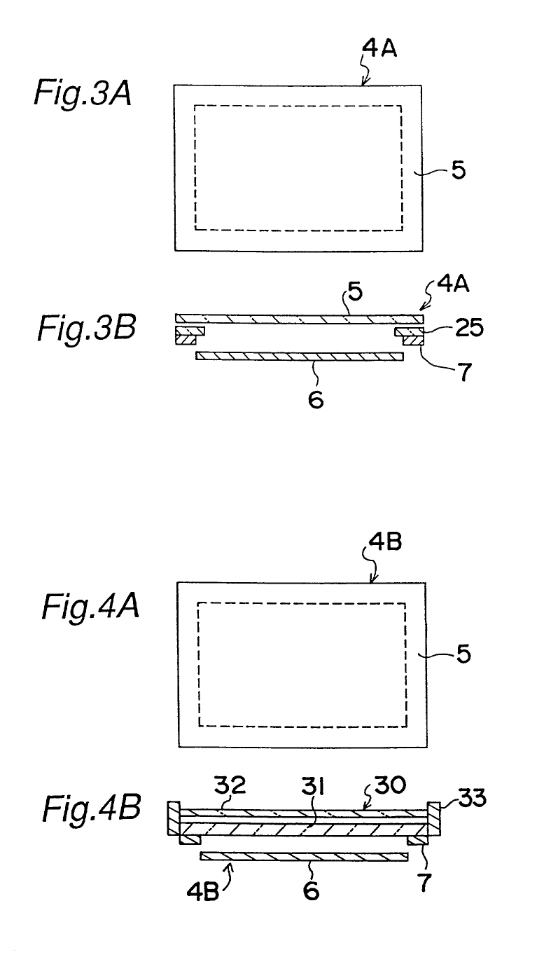

FIGS. 3A and 3B show a display device generally indicated by reference numeral 4A. In this embodiment, the light source 7 is supported on a frame or substrate 25. The frame 25 is fixed or bonded on the protection cover 5 so that the light source 7 opposes to the periphery of the display panel 6. According to this embodiment, it is not necessary for the light source 7 to be attached onto the protection cover 5 directly, which causes the display device to be manufactured easily.

Third Embodiment

Referring to FIGS. 4A and 4B, the display panel 4B of this embodiment has a touch panel 30 on the light source 7. The touch panel 30 has a transparent substrate 31, a transparent cover film 32 provided on the panel 31, and a frame or sealing member 33 extending around peripheries of the substrate 31 and the film 32. The organic electroluminescent light source 7 is provided on a surface of the substrate 31 opposing the display panel 6 and along a periphery of the substrate 31 so that it surrounds the display panel 6. The touch panel may be an analogue touch panel or a matrix touch panel.

According to this embodiment, since the substrate 31 is used not only as a part of the touch panel 30 but also as a support of the light source 7. This reduces the number of parts of the display device, which results in a high quality, lightweight, compact, and bright display device.

Fourth Embodiment

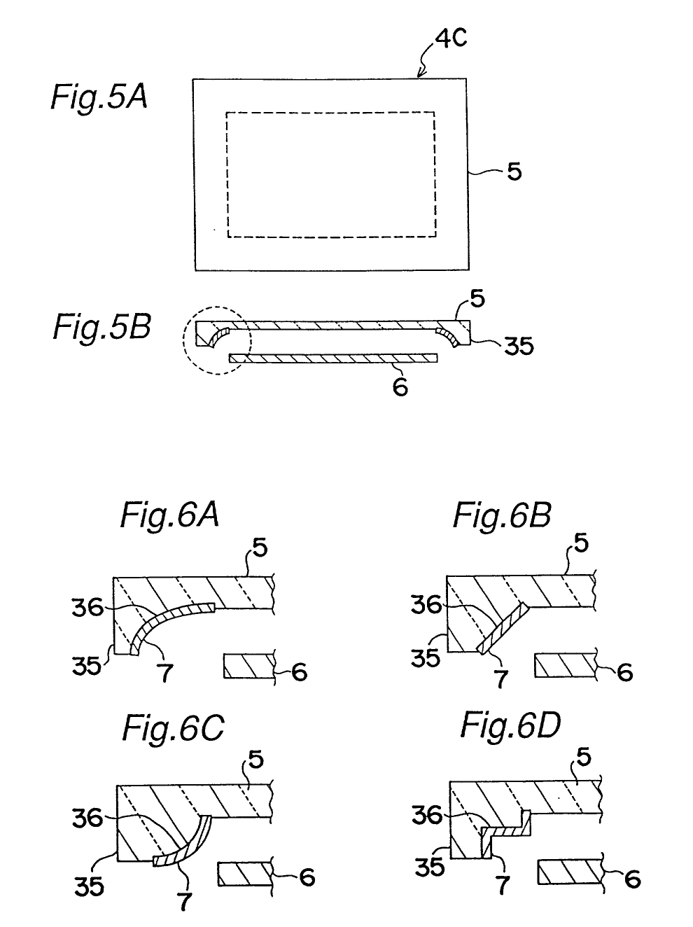

Referring to FIGS. 5A and 5B, according to the display device generally indicated by reference numeral 4C of this embodiment, the protection cover 5 is formed at its periphery with a flange 35 projected toward the display panel 6. As best shown in FIG. 6A, an inner surface 36 of the flange 35 is outwardly curved, on which the organic electroluminescent light source 7 is attached so that light emitted from light source 7 is directed or focused onto the peripheral portion of the display panel. This maximizes an amount of light to be received by the display panel. Also, another arrangement of the light source 4 may be employed so as to increase and/or decrease light to be received at specific portion or portions of the display panel.

The inner surface 36 of the flange 35 determining the cross-sectional configuration of the light source may have another configuration. For example, the inner surface may be slanted (FIG. 6B), inwardly curved (FIG. 6C), or stepped (FIG. 6D).

Fifth Embodiment

FIGS. 7A and 7B show a method for manufacturing the L-shaped organic electroluminescent light source. As briefly described in the second embodiment, first prepared is an organic electroluminescent sheet 20 in the form of rectangular plate, for example. As shown in FIG. 2, the sheet has substrate, first electrode layer, organic light emitting layer, second electrode layer, and protection layer. Those layers are superimposed on the substrate by a suitable deposition technique, for example. Next, referring back to FIG. 7B, the sheet 20 is cut into L-shaped pieces 30. Each piece 30 is combined with another piece to form a rectangular frame, i.e. light source. This facilitates the manufacturing of the light source. Also, the materials can be used so effectively. Although the piece is shaped in the form of “L” in this embodiment, it may be in the form of strip.

Each of the above-described embodiments may be modified in various ways. For example, the display panel may be any type of non-light-emitting element such as reflection type and transmission type liquid crystal elements. The liquid crystal element may be chosen from various available elements including a reflective, cholesteric liquid crystal element that provides a cholesteric phase at an atmospheric temperature.

In general, for the reflection type liquid crystal display element using a selective reflection feature of the cholesteric liquid crystal, its efficiency of light is less than 50%. This requires light to be projected into the liquid crystal element as much as possible. On the other hand, it is preferably not to arrange, on the viewer side of the liquid crystal element, an optical element which would diffuse light and thereby result in the deterioration of contrast. In this regard, the display element in the previous embodiments receives light directly from the organic electroluminescent element. This maximizes the amount of light to be received by the display element. Also, since no light guide is provided on the viewer side of the display element, a bright and high contrast image can be provided.

Further, although the organic light electroluminescent element is used for the light source, it may be replaced by an inorganic electroluminescent element. It should be noted that the organic electroluminescent element is preferable because it can be driven with a lower voltage and manufactured easily.

According to the present invention, for the display device with the non lightemitting display element such as reflection type liquid crystal display element, the light source and the display can be thinned and then small sized. This in turn allows the display device to be designed into various configurations.

Also, no light guide is provided on the display element, which results in a bright, high contrast, and improved quality image.

Further, since the electroluminescent element is positioned outside the display region. This prevents the element from hindering the display of the image.

Furthermore, the plate-like substrate of the organic electroluminescent light source may also be used for the support plate of the touch panel.

Moreover, the configuration of the organic electroluminescent light source may be changed depending upon the design requirements including a compactness of the display device and an illumination condition of the display element, for example.

Also, according to the method for manufacturing the display device, the light source is assembled by plural pieces or units, allowing its materials to be used so effectively.

Sixth Embodiment

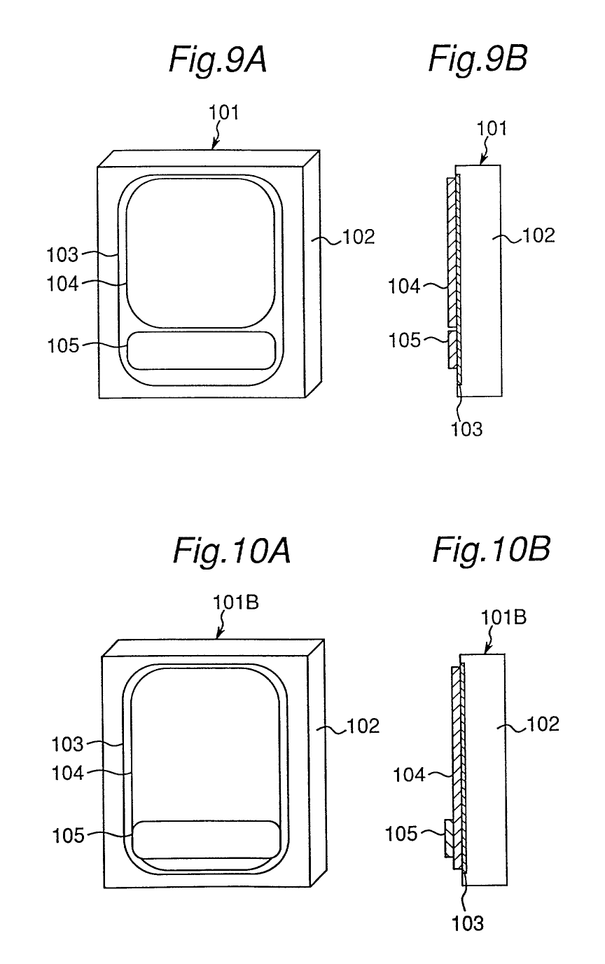

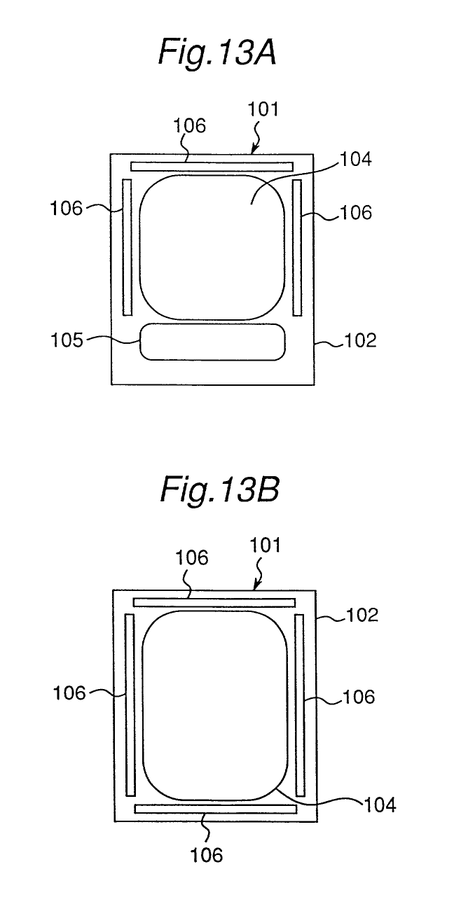

Referring to FIGS. 9A and 9B, the liquid crystal display device generally indicated by reference numeral 101 has a frame or housing 102. The housing 102 supports a display panel 103, a front light unit 104 provided on an upper surface portion of the display panel 103 for the illumination of the display panel, an input touch panel unit 105 provided on a lower surface portion of the display panel 103 for the input of data using a dedicated input pen (not shown), and an input/output control (not shown) for controlling the display panel 103 and the touch panel unit 105. Although eliminated from FIGS. 9A and 9B for clarity but as shown in FIG. 13A, a plurality of light sources 106 are positioned around the front light unit 104. Preferably, a cold cathode tube is used for the light source 106. The light sources 106 are also controlled by the input/output controller.

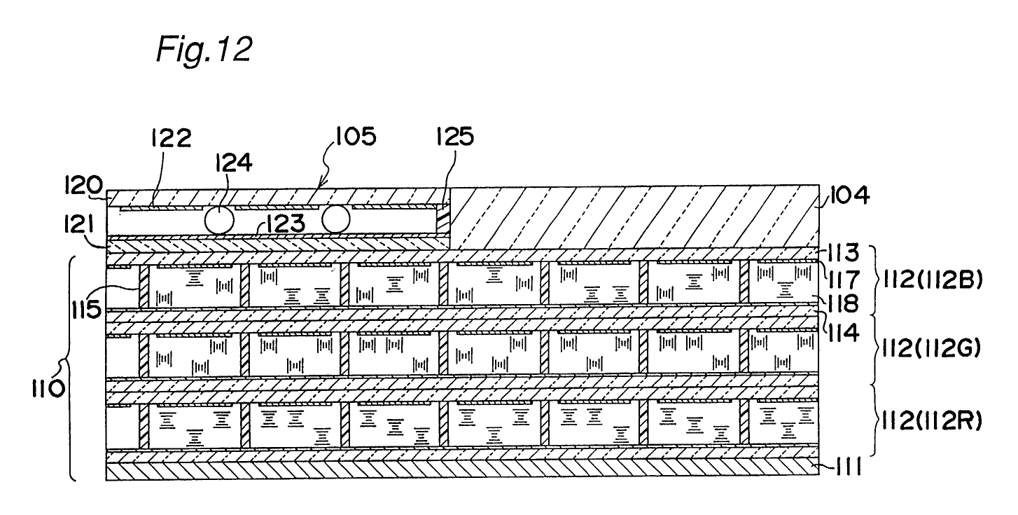

Referring to FIG. 12, there is shown a part of the display panel 103, the front light unit 100, and the touch panel 105. The display panel 103 has a liquid crystal panel 110. The liquid crystal element 110 is supported on a light absorbing layer 111 positioned on the other surface thereof away from the viewer.

Here, a brief discussion will be made to the liquid crystal element 110 hereinafter. The liquid crystal element 110 includes three color display layers 112, i.e., red display layer 112R, green display layer 112G, and blue display layer 112B, on the light absorbing layer 111.

Each display layer 112 includes top and bottom substrates, 113 and 114, both made of transparent material, a resin structure 115 positioned and bonded between the substrates, and a liquid crystal 116 filled between the substrates. Although not shown in the drawing, a number of spacing balls are positioned between the top and bottom substrates for maintaining the constant gap therebetween. A plurality of transparent, strip-like upper electrodes 117 are positioned in a parallel fashion and spaced apart from another on one surface of the upper substrate 113, opposing the bottom substrate. On the other hand, a plurality of transparent, strip-like electrodes 118 are positioned in a parallel fashion and spaced apart from another on one surface of the lower substrate 114, opposing the top substrate. The upper electrodes 117 are directed perpendicular to the lower electrodes 118, so that each of the intersections of the upper and lower electrodes defines a pixel of the liquid crystal display element 110. Also, each pixel displays a small part of the image in a corresponding small effective display region between the top and bottom transparent substrates.

In this embodiment, used for the liquid crystal 116 in each of the display layers is a cholesteric liquid crystal capable of selectively reflecting a part of visible light. Specifically, the display layer 112B, 112G, and 112R employ liquid crystals that selectively reflect blue, green, and red light, respectively. The upper substrate in one layer may be used for the lower substrate of the upper substrate in the neighboring layer, and vice versa. This reduces the number of substrates, improving the quality of the resultant image.

In response to a voltage applied between the upper and lower electrodes 117 and 118 opposing through the liquid crystal 116, the display layer 112 changes between a transmission state where the liquid crystal allows light to pass therethrough and a reflection state where the liquid crystal reflects the associated light. Therefore, when one display layer 112 is kept in the reflection state and another layer or layers positioned on the viewer side are kept in the transmission state, the one display layer in the reflection state reflects an associated part of white light or natural light directed from above into the display panel 103, which an image of the associated color is displayed. When on the other hand all of the display layers are set to be transparent state, light is all absorbed by the light absorbing layer 111 so that no color except black is displayed.

The cholesteric liquid crystal contained in each of the display layers may be a liquid crystal material capable of representing a cholesteric phase in the room temperature or another liquid crystal material made by nematic liquid material added with chiral material. The cholesteric liquid crystal material takes a planer state when it is applied with a relatively high voltage and a focal conic state when it is applied with a relatively low voltage. Also, when an intermediate voltage between the relatively high and low voltages is applied to the cholesteric liquid crystal, the liquid crystal takes a third state in which the planer and focal conic states coexist. The cholesteric liquid crystal in the planer state selectively reflects light having a wavelength of X indicated by the following equation:

λ=P·n

wherein P represents a pitch of spiral, and n represents an average index of refraction of the liquid crystal. When the cholesteric liquid crystal takes the focal conic state and also the wavelength to be reflected by the liquid crystal ranges in the infrared region, the visible light is diffused. When the wavelength of light to be reflected ranges in another region lower than the infrared region, the diffusion decreases so that the visible light becomes to be transmitted. When the cholesteric liquid crystal is in the intermediate state between the planer and the focal conic states, a halftone image is displayed. This means that by setting the wavelength of light to be reflected within the range of visible light and also arranging the light absorbing layer 111 on the bottom of the display panel 4, away from the viewer, the displaying color can be changed between the specific color (i.e., color in the planer state), the black color (i.e., color in the focal conic state), and the halftone color.

For example, by setting the cholesteric liquid materials in the blue and green display layers 112B and 112G into the focal conic state, i.e., transmission state, and the cholesteric liquid material in the red display layer 112R into the planer state, i.e., reflective state, a red image is displayed. Also, by setting the cholesteric liquid materials in the green and red display layers 112G and 112R into the focal conic state, i.e., transmission state, and the cholesteric liquid material in the red display layer 110B into the planer state, i.e., reflective state, a yellow image is displayed. Likewise, by changing the states of the display layers 112 between the transmission and the reflective states, the display panel can display various colors including red, green, blue, white, cyan, magenta, yellow, and black, allowing the display panel to display a full color image. In addition, by setting any of the display layers 112 into the intermediate state, the halftone can be displayed. It should be noted that each of the states (i.e., focal conic, planer, and intermediate states) is maintained without any supply of the voltage. This means that the display device has a memory characteristic.

Referring also to FIG. 12, the display panel 103 supports the touch panel 105. The touch panel may be a matrix touch panel or an analogue touch panel. Also, the touch panel may have any resolution or sensitivity. In this embodiment, the touch panel 105 has transparent, top and bottom sheets 120 and 121. The top sheet 120 supports a plurality of upper transparent strip-like electrodes 122 fixed on one surface opposing the bottom sheet. On the other hand, the bottom sheet 121 supports a plurality of lower transparent strip-like electrodes 123 spaced away from and extending perpendicular to the upper electrodes. A number of spacing members 124 are positioned between the top and bottom sheets so that a constant gap is defined between the top and bottom sheets. The top and bottom sheets 120 and 121 are connected by a sealing member 125 arranged between peripheral edges of the sheets. Preferably, the upper and bottom electrodes are made of indium-tin oxide (ITO). As shown, since the touch panel 105 is positioned on the display panel 100 in this embodiment, a display such as keys and/or message can be displayed in a portion of the display panel 110 located behind the touch panel 105.

According to the sixth embodiment of the present invention, the display panel 103 is provided with the illumination and input features. Also, the front light unit and the touch panel are positioned in different places. This minimizes not only the decrease of brightness but also the deterioration of the image quality. Further, the display panel 103 can be enlarged in the liquid crystal display device 101. Furthermore, the liquid display can be positioned in the data input region, i.e., in the region of the touch panel unit. The illumination and input features may be provided only for a part of the display region. For example, the touch panel is designed so that it can be used in a light place. On the other hand, the display panel is designed so that various images including telephone number and E-mail can be read even in a dark place.

Seventh Embodiment

Referring to FIGS. 10A and 10B, the liquid crystal display device generally indicated by reference numeral 101B has an enlarged front light unit 104 in which the data input region or touch panel unit 105 is positioned. Also, as shown in FIG. 13B, the light sources 106 are positioned around the front light unit 104 so that the display panel can be illuminated from every direction, i.e., from its upper, lower, left and right sides. This allows the display device to provide a bright, high quality image. Also, the image can be displayed even in the data input region, i.e., under the touch panel 105.

Eighth Embodiment

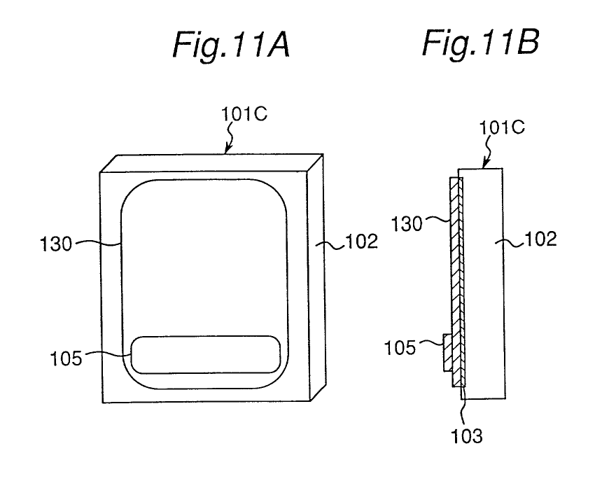

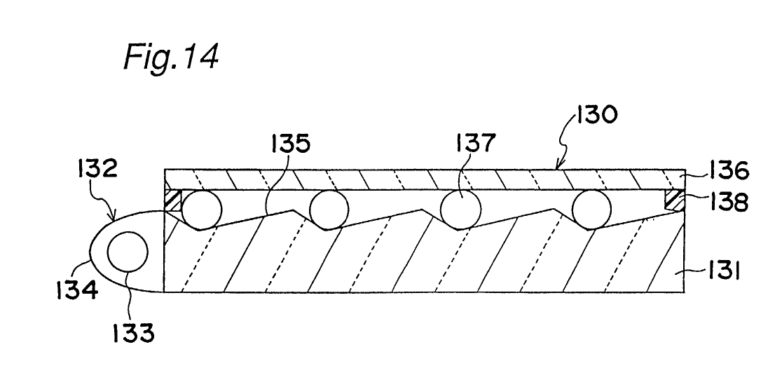

Referring to FIG. 11, the display device generally indicated by reference numeral 101C has a front panel 130 on the display panel 104. The front panel 130 is a combination of the front light unit and the touch panel unit. Specifically, as shown in FIG. 14, the front panel 130 has a thinned light guide plate 131 and the light source 132. The light source 132 has a lamp 133. The lamp 133 may be a white LED, fluorescent lamp, or cold cathode tube, for example. The light source 132 also includes a reflector 134 so that light emitted from the lamp 133 is effectively transmitted into the light guide 131.

The light source 132 is arranged along the upper, lower, left and right edges of the front panel 130. However, the light source 132 may be arranged adjacent only a part of the peripheral edge of the front panel.

The thinned light guide plate 131, which is preferably made of transparent acrylic resin, has a plurality of columns 135 in the form of ridge, each extending in one direction, so that light from the light source 132 is effectively guided reflected by the columns 135 toward the display panel 103. The light guide plate 131 may have an anti-reflection layer on its bottom surface opposing the display panel 103.

A protection cover 136 is positioned above the guide plate 131. Positioned between the protection cover 136 and the guide plate 131 are a number of spacing balls 137 for keeping a constant gap therebetween. Similar to the above-described touch panel, the protection cover 136 and the guide plate 131 supports a number of parallel electrodes on opposing surfaces thereof, respectively. The electrodes on the protection cover 136 extend perpendicular to those on the guide plate 131. The protection cover 136 and the guide plate 131 are sealed at peripheral edges thereof by a sealing member 138. Preferably, the electrodes are made of indium-tin oxide (ITO).

This allows that not only the image can be displayed but also the information can be input in the same, entire area of the front panel 130. As described above, the structure of touch panel unit in the front panel 130 is similar to that of the touch panel unit 105 illustrated in FIG. 12. However, the touch panel unit of the front panel 130 may be different from the touch panel unit 105 positioned on the front panel 140. For example, the touch panel unit 105 may have a greater resolution and sensitivity than that in the front panel 130.

In general, the greater resolution and sensitivity tends to complicate the structure of the touch panel, which deteriorates the light transmission as well as the recognition of the image. However, the touch panel unit 105 with high resolution and sensitivity is limited in a small area. This reduces the deterioration of the brightness and quality of the image, compare with the display device in which the high resolution and sensitivity touch panel is arranged over the entire surface of the front light unit.

Also, in this embodiment, the light guide plate 131 can be used as the bottom substrate of the touch panel unit, which reduces the number of components of the display panel.

Ninth Embodiment

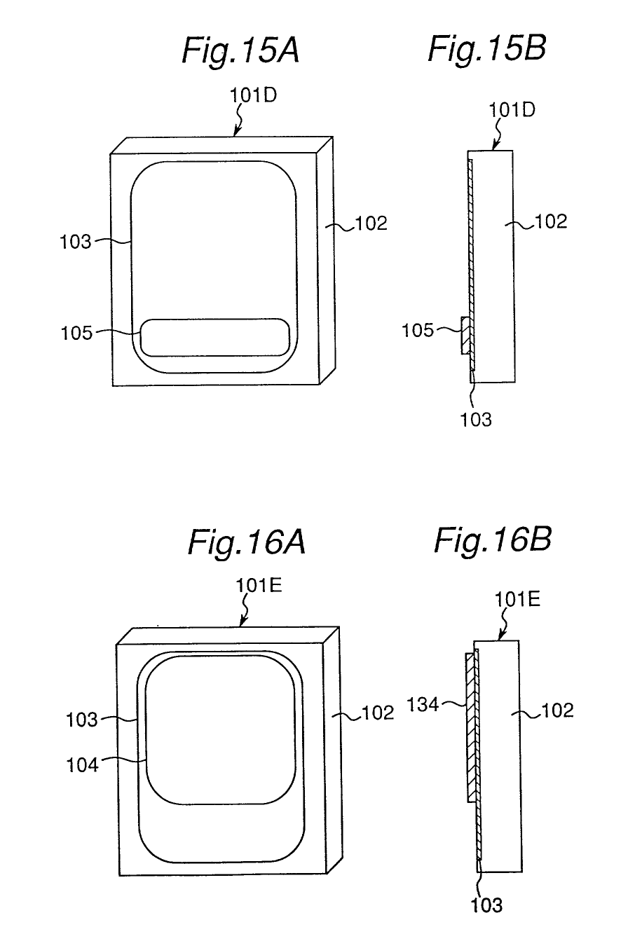

Referring to FIG. 15, the display device generally indicated by reference numeral 101D has only the high resolution and sensitivity touch panel unit 105 on a small area, e.g., lower portion, of the display panel 103. This allows the display panel 103 to display images with a higher brightness and quality.

Tenth Embodiment

Referring to FIG. 16, in the display device generally indicated by reference numeral 101E, the front light unit 104 positioned on the display panel 103 is sized so that a part of the display panel 103 is exposed around the front light unit 104. The exposed part of the display panel 103 may be covered by a transparent protection cover not shown.

Eleventh Embodiment

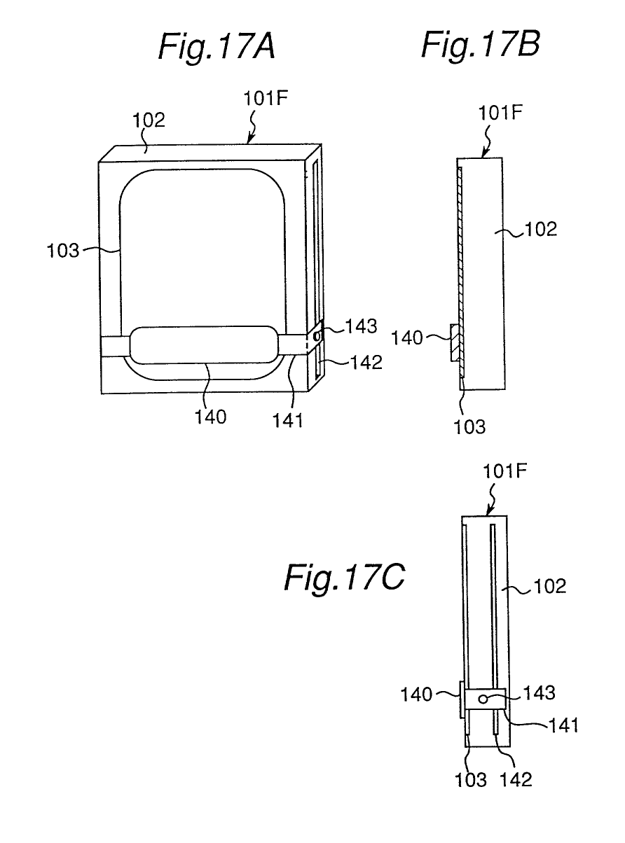

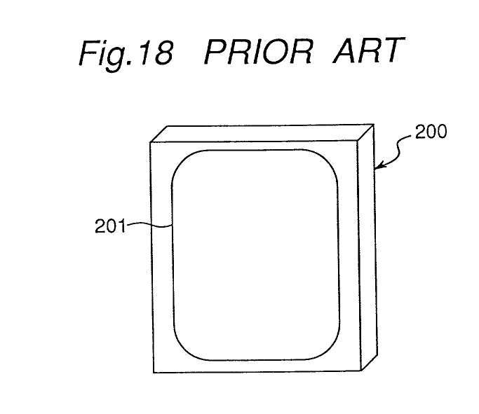

Referring to FIGS. 17A, 17B, and 17C, in the display device generally indicated by reference numeral 101F, a touch panel unit 140 is movably positioned on the display panel 103. The touch panel unit 140 has a pair of L-shaped arms 141. The arms 141 are connected at one ends thereof to the opposite ends of the touch panel unit 140 and engaged at the other ends thereof with left and right sides walls of the housing 102. For the mechanical connection between the arms and housing, each of the left and right side walls of the housing 102 is formed with a groove 142 extending vertically. Each arm 141 on the other hand is formed with a projection (not shown) that engages with the groove 142. In order to fix the touch panel unit 140 on the display panel 103, at least one of the arms 142 has a suitable fixing member such as screw 143. Although not shown, the touch panel unit 140 is electrically connected with the control unit in the housing 102 by the contact of electrodes provided on the arms and the opposing surface portion of the housing 102, respectively.

According to the display panel, the touch panel unit 140 can be moved up and down and then fixed at any position by the operation of screw 143.

Alternatively or additionally, the front light unit may be designed to move vertically and/or horizontally.

Also, the touch panel unit and/or the front light unit may be removable from the display device. In this instance, the housing may be formed with a corresponding concave portion in which the touch panel unit and/or front light unit is embedded.

Twelveth Embodiment

In the display device 101 shown in FIGS. 9A and 9B, the front light unit 104 may be replaced by the second touch panel unit having a certain resolution and sensitivity that is different from that of the first touch panel unit 105. This allows the display device to display images with increased brightness and contrast than the display device in which the high resolution and sensitivity touch panel covers the entire area of the display panel.

Although the present invention has been fully described in accordance with a variety of embodiments, it may be modified in various ways without departing from the scope of the present invention. For example, the liquid crystal in the liquid crystal panel is not limited to the reflection type liquid crystal and it may be transmission type liquid crystal. In this instance, the light absorbing layer is replaced with a reflector.

Also, the liquid crystal panel is not limited to the layered panel with a plurality of liquid crystal display layers and it may be a single layer liquid crystal panel.

As can be seen from above, the touch panel and/or the light guide plate are positioned on only a part of the display panel. This causes the remaining part of the display panel to display a bright image. Also, the touch panel and the light guide plate positioned on the display panel does not restrict the size of the display panel. Further, the display device can be minimized. Furthermore, for display device with the reflection type liquid crystal can receive sufficient light from its viewer side, allowing the device to display a bright image. In particular, this is so effective to the display device with a layered liquid crystal panel.

What is claimed is:

1. A display apparatus, comprising:
a display element which emits no light therefrom; and
an electroluminescent element provided on a viewer side of the display element for a direct illumination of the display element.

2. A display apparatus in accordance with claim 1, wherein the electroluminescent element is positioned outside the display element when viewed from the viewer side.

3. A display apparatus in accordance with claim 1, wherein the electroluminescent element is positioned outside and around the display element when viewed from the viewer side.

4. A display apparatus in accordance with claim 1, wherein the electroluminescent element is positioned to surround the display element when viewed from the viewer side.

5. A display apparatus in accordance with claim 1, further comprises a support member positioned on the viewer side of the display element, wherein the electroluminescent element is positioned on one side of the support member, opposing the display element.

6. A display apparatus in accordance with claim 5, wherein the support member covers an entire display region of the display element.

7. A display apparatus in accordance with claim 1, further comprises a plate-like position input device positioned on the viewer side of the display element, wherein the electroluminescent element is positioned on one surface of the position input device, opposing the display element.

8. A display apparatus in accordance with claim 1, wherein the electroluminescent element is shaped so that it provides an even illumination to the display element.

9. A display apparatus in accordance with claim 1, wherein the electroluminescent element is shaped so that it provides a first illumination to a first part of the display element and a second illumination to a second part of the display element, the first illumination being greater than the second illumination.

10. A display apparatus in accordance with claim 1, wherein the electroluminescent element is made from one piece of electroluminescent member or assembled by two or more pieces of electroluminescent member.

11. A display apparatus in accordance with claim 1, wherein the display element is a reflection type liquid crystal display element.

12. A display apparatus in accordance with claim 1, wherein the display element is a reflection type liquid crystal display element using a selective reflection by a cholesteric phase.

13. A method for manufacturing a display device, comprising the steps of:
providing a display element;
using an electroluminescent member or assembling two or more electroluminescent members to form a light source; and
positioning the light source on a viewer side of the display element.

14. A display device, comprising:
a display element having a display region; and
a transparent element positioned on a viewer side of the display element so that the transparent element covers only a part of the display region of the display element.

15. A display device in accordance with claim 14, wherein the transparent element is a touch panel.

16. A display device in accordance with claim 14, wherein the transparent element is a light guide plate for guiding light from an atmosphere into the display panel.

17. A display device in accordance with claim 14, wherein the transparent element functions as an input touch panel and a light conducting plate.

18. A display device in accordance with claim 16, further comprises a light source for an illumination of the light guide.

19. A display device in accordance with claim 14, wherein the transparent element is positioned so that it moves on the display region of the display element.

20. A display device in accordance with claim 14, wherein the display device includes two transparent elements, each of the two transparent elements takes different positions on the display region of the display element.

21. A display device in accordance with claim 20, wherein either one of the two transparent elements functions as an input touch panel and/or a light conducting plate.

22. A display device in accordance with claim 14, wherein the display device includes a plurality of superimposed transparent elements and wherein at least one of the transparent elements covers only a part of the display region of the display element.

23. A display device in accordance with claim 22, wherein at least one of the transparent elements covers the entire display region of the display element.

24. A display device in accordance with claim 22, wherein the transparent element covering the part of the display region is a touch panel.

25. A display device in accordance with claim 14, wherein the display element is a liquid display panel.

26. A display device in accordance with claim 14, wherein the display element is a reflection type liquid crystal display panel.

27. A display device in accordance with claim 25, wherein the liquid crystal display panel is a reflection type liquid crystal panel including a liquid crystal that takes a cholesteric phase in a room temperature.

28. A display device in accordance with claim 25, wherein the display element is a layered liquid crystal display panel with a plurality of liquid crystal layers.

29. A display device in accordance with claim 20, wherein the transparent elements are touch panels, the touch panels being different in resolution and/or sensitivity thereof.

30. A display device in accordance with claim 15, wherein the touch panel includes first and second regions, the first and second regions being different in resolution and/or sensitivity thereof.
